(19) United States
(12) Patent Application Publication
(10) Pub. No.: US 2019/0260891 A1
(43) Pub. Date: Aug. 22, 2019

(54) ELECTRICAL APPARATUS FOR WHICH VARIOUS SETTINGS ARE PERFORMED BY USER OPERATING OPERATION PANEL

(71) Applicant: KYOCERA Document Solutions Inc., Osaka (JP)

(72) Inventor: Naoki NAKAJIMA, Osaka (JP)

(73) Assignee: KYOCERA Document Solutions Inc., Osaka (JP)

(21) Appl. No.: 16/275,903

(22) Filed: Feb. 14, 2019

(30) Foreign Application Priority Data
Feb. 22, 2018 (JP) 2018-029606

(51) Int. Cl. H04N 1/00

(52) U.S. Cl. CPC H04N 1/00517; H04N 1/00411; H04N 2201/0094; H04N 1/00416; H04N 1/00474

(57) ABSTRACT

Provided is an electrical apparatus that realizes an operation that can simplify an operation by reflecting a past operation history by a user without inviting an increase in storage capacity. Information of a stepwise operation procedure is identified for each user and stored in a storage unit. Therefore, for example, a case is described in which a control unit recognizes a user when the user uses an image forming apparatus. In this case, when reading the most recent stepwise operation procedure by the user from the storage unit and newly displaying an operation panel on a touch-panel display, a display based on the information stored in this way is performed on the touch-panel display. In this image forming apparatus, the control unit reduces the amount of information stored by deleting a part of the information stored as a stepwise operation procedure after elapse of a first holding time.

### INCORPORATION BY REFERENCE

This application is based on and claims the benefit of priority from Japanese Patent Application No. 2018-029606 filed on Feb. 22, 2018, the contents of which are hereby incorporated by reference.

### BACKGROUND

The present disclosure relates to an electrical apparatus for which various settings are performed by a user operating an operation panel.

In various electrical apparatuses, an operation panel for making various settings is provided, and a desired operation is performed by a user operating the operation panel. Actually, in many cases the operation panel is provided on a touch-panel display. For example, when a certain operation is performed, in other words, when a certain operation key on the operation panel is operated, this operation panel is deleted and a new operation panel for performing the next operation is displayed, and hierarchical operations are also performed for prompting that the next instructions be performed. At this time, it is possible to return to a previous screen (operation panel) and to redo the operation in order to handle operation mistakes or the like. By performing such hierarchical operations, it is possible to reduce the number of operation keys displayed at the same time, and it is also possible to suppress operation errors by the user.

Such an operation is particularly effective in a multifunction peripheral (MFP: Multi Function Printer) that is equipped with many functions in a single apparatus. In a multifunction peripheral, for example, an operation for selecting any one of “copy”, “scanner”, “facsimile”, and the like is performed on the initial screen. For example, when “copy” is selected, a screen for performing an operation for selecting an operation such as setting of paper to be used next, adjustment of an image, setting of magnification and the like is displayed. Here, after the operation is selected, the screen shifts to an adjustment screen corresponding to the operation selected here.

In general, in many cases only one multifunction peripheral is installed in one workplace, and in many cases this one is used by many users. In this case, the hierarchical operation as described above is performed individually by each user. In a typical technique, considering such a situation, there is a multifunction peripheral that can store the operation when the user used this multifunction peripheral in the past, and can automatically perform the stored operations again after the user has read and confirmed the stored operations. Here, it is also possible to perform operations to which small changes having been made to past operations that have once been read. In addition, it is possible to newly store in memory or overwrite operations to which small changes have been made. In doing so, the operation can be performed in an efficient manner, and operation errors can be reduced.

### SUMMARY

The electrical apparatus according to the present disclosure is an electrical apparatus that uses an operation panel equipped with a plurality of keys to be operated by a user, and during use, by using the operation panel operated by the user in a stepwise manner according to the operation of the user, the electrical apparatus operates after various settings are performed. The electrical apparatus includes a storage unit and a control unit. The storage unit stores a stepwise operation procedure that specifies operations performed by the user on the stepwise operation panel in the past. The control unit causes the stepwise operation procedure stored in the storage unit to be displayed, and prompts the user to operate the operation panel. Furthermore, the control unit deletes a part of information of the stepwise operation procedure stored in the storage unit after a first holding time that is set according to an attribute or operation history of the operation key related to the part of the information on the operation panel has elapsed.

### BRIEF DESCRIPTION OF THE DRAWINGS

FIG. 1 is a block diagram illustrating a configuration of an image forming apparatus of an embodiment according to the present disclosure.

FIG. 2A is a diagram illustrating an example of a screen when performing settings in steps in an image forming apparatus.

FIG. 2B is a diagram illustrating an example of a screen when performing settings in steps in an image forming apparatus.

FIG. 2C is a diagram illustrating an example of a screen when performing settings in steps in an image forming apparatus.

FIG. 2D is a diagram illustrating an example of a screen when performing settings in steps in an image forming apparatus.

FIG. 3 is a first example of a display in the case where data of a stepwise operation procedure is used in an image forming apparatus of an embodiment according to the present disclosure.

FIG. 4 is a second example of a display in the case where data of a stepwise operation procedure is used in an image forming apparatus of an embodiment according to the present disclosure.

FIG. 5A is a third example of a display in the case where data of a stepwise operation procedure is used in an image forming apparatus of an embodiment according to the present disclosure.

FIG. 5B is a third example of a display in the case where data of a stepwise operation procedure is used in an image forming apparatus of an embodiment according to the present disclosure.

FIG. 5C is a third example of a display in the case where data of a stepwise operation procedure is used in an image forming apparatus of an embodiment according to the present disclosure.

FIG. 6 is a fourth example of a display in the case where data of a stepwise operation procedure is used in an image forming apparatus of an embodiment according to the present disclosure.

FIG. 7 is a fifth example of a display in the case where data of a stepwise operation procedure is used in an image forming apparatus of an embodiment according to the present disclosure.

FIG. 8A is an example of a display when setting whether or not to delete a part of the information in the image forming apparatus of an embodiment according to the present disclosure.

FIG. 8B is an example of a display when setting whether or not to delete a part of the information in the image forming apparatus of an embodiment according to the present disclosure.

FIG. 8C is an example of a display when setting whether or not to delete a part of the information in the image forming apparatus of an embodiment according to the present disclosure.

FIG. 8D is an example of a display when setting whether or not to delete a part of the information in the image forming apparatus of an embodiment according to the present disclosure.

FIG. 9 is an example of a flowchart illustrating an operation in an image forming apparatus of an embodiment according to the present disclosure that is performed according to an operation by a user.

### DETAILED DESCRIPTION

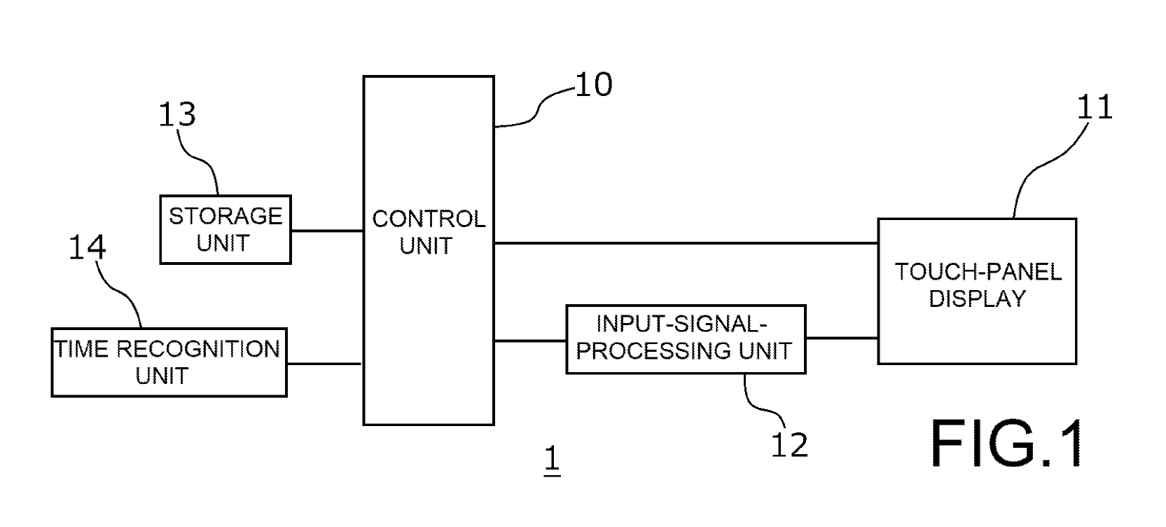

Hereinafter, modes for carrying out the technique according to the present disclosure will be described with reference to the drawings. The electrical apparatus of an embodiment is a multifunction peripheral (image forming apparatus) including a touch-panel display. This image forming apparatus is equipped with various functions including a function for forming and outputting an image on a medium, so many setting items are provided. FIG. 1 is a block diagram illustrating a configuration of this image forming apparatus 1. Here, this image forming apparatus 1 is provided with, for example, a function for forming an image on a medium, a mechanism for optically reading an image from a document, a facsimile function and the like. However, here, only the constituent elements directly related to the present disclosure are illustrated, and descriptions of the constituent elements related only to each of the above functions are omitted. As illustrated in FIG. 1, the image forming apparatus 1 includes a touch-panel display 11 for input and output. The touch-panel display 11 is similar to the conventionally known resistive film type and electrostatic capacitance type, and functions as a display unit for displaying various kinds of information and two-dimensional images. At the same time, an input-signal-processing unit 12 can electrically recognize a touched location when a finger of a user touches the surface thereof. Therefore, in the case where an image (operation panel) corresponding to an arrangement of the operation keys is displayed on the touch-panel display 11 and a user's finger touches locations corresponding to each operation key, the operation keys on the operation panel can be recognized as having been operated. Therefore, this operation panel can be handled in the same way as a keyboard or the like of a personal computer.

A control unit 10 equipped with a CPU can perform various settings for the operation of the image forming apparatus 1 based on input by the touch-panel display 11 (operation panel) as described above. In addition, a storage unit 13 for storing various data and a time recognition unit 14 for recognizing the current time are provided for operating this image forming apparatus 1. The control unit 10 can read various kinds of data by referencing the storage unit 13, and perform various operations. At this time, by having a user login or the like via the touch-panel display 11, the control unit 10 can recognize the user currently using the image forming apparatus 1.

For example, when performing an operation, the control unit 10 causes the touch-panel display 11 to display an operation panel of operations to be performed, then as described above, recognizes which operation key is operated on this operation panel. After that, the operated operation panel is deleted, a new operation panel for performing the setting of the selected operation is displayed on the touch-panel display 11, and this setting is received in the same manner as described above by a new operation. After that, in order to perform a more detailed setting related to the selected setting, a new operation panel is displayed on the touch-panel display 11 and input is received. In this way, the operation using the operation panel is performed in a stepwise manner until the setting is completed so that a state occurs in which operation becomes possible.

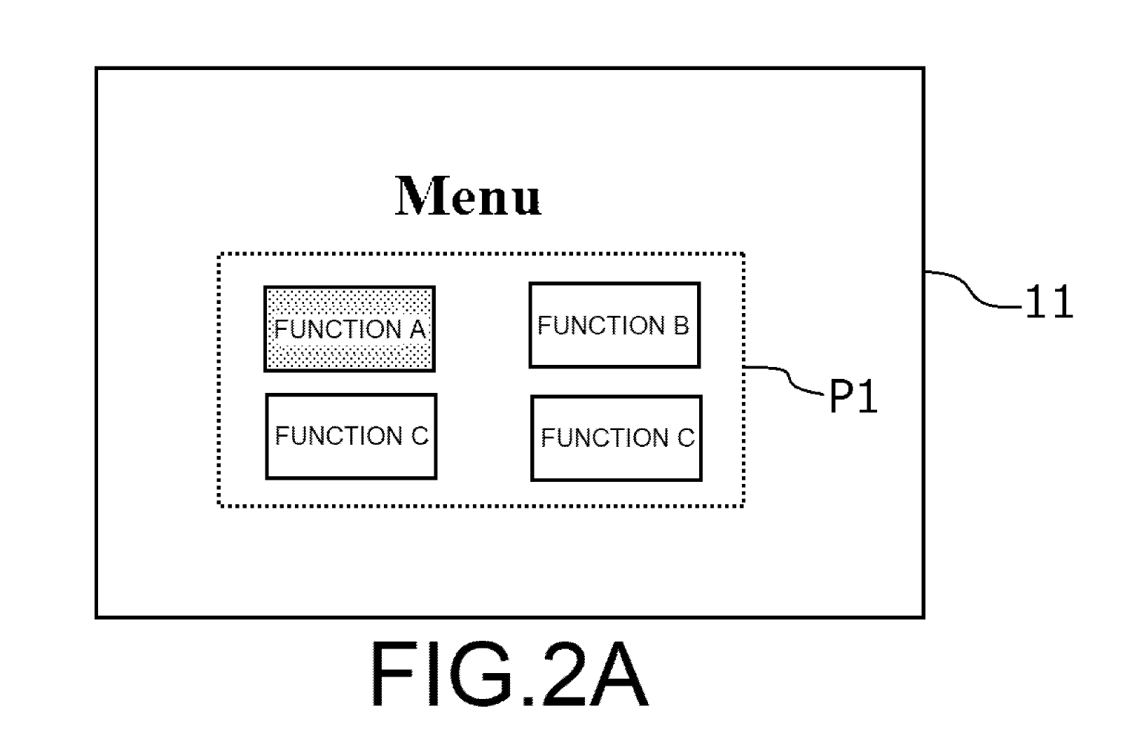

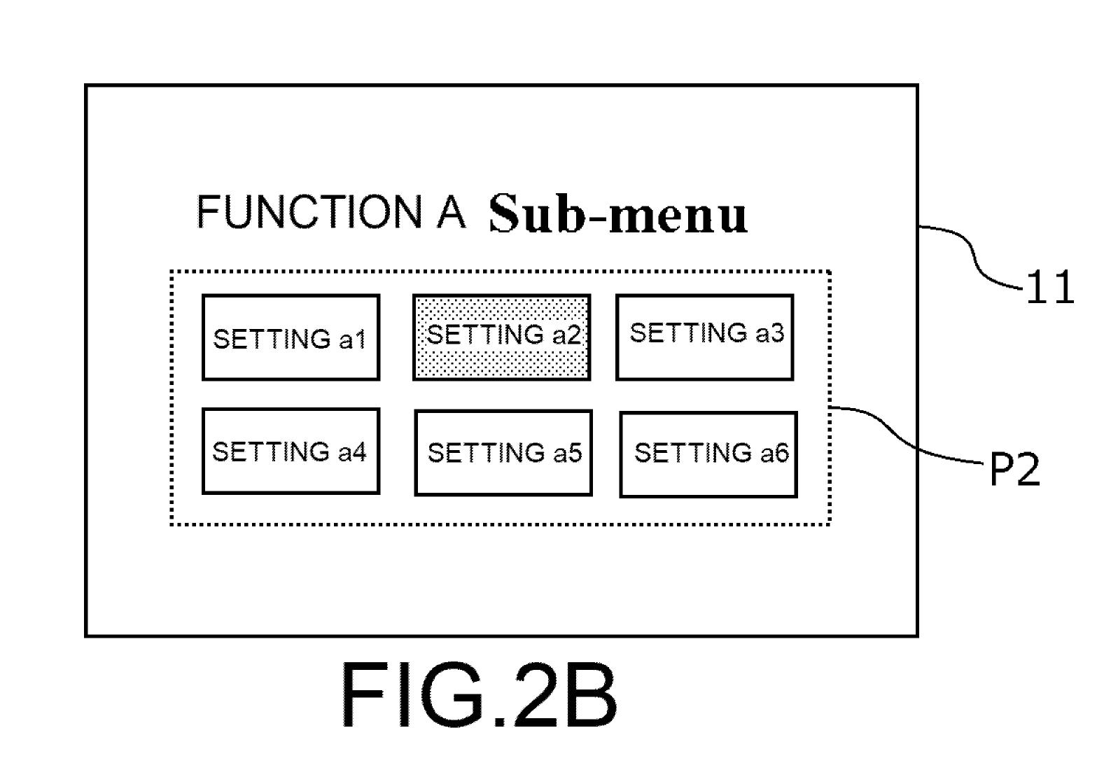

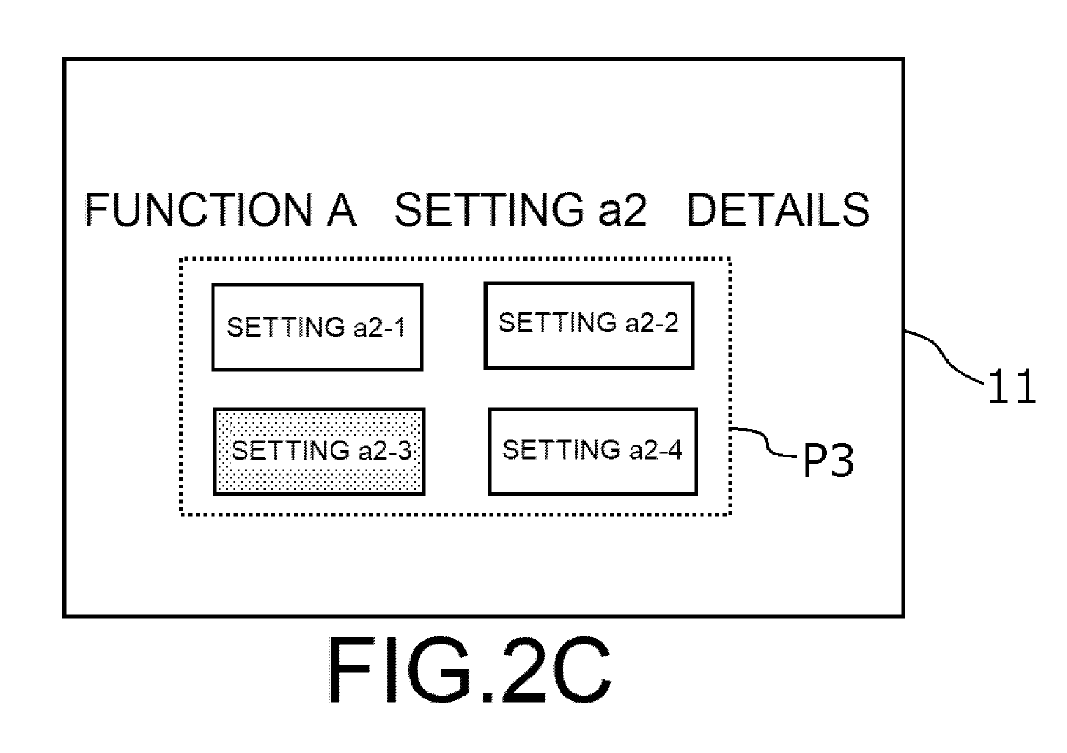

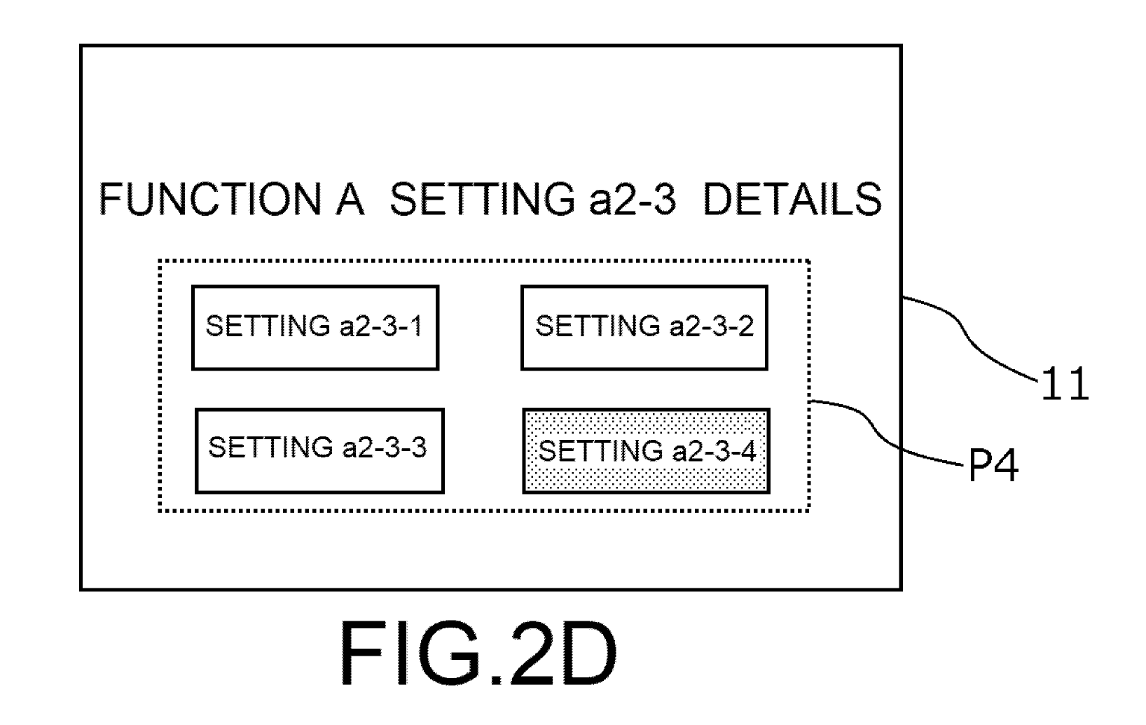

FIG. 2A to 2D illustrate the transition of the image displayed on the touch-panel display 11 by the control unit 10 in this way. Here, as illustrated in FIG. 2A, first, an inquiry is made using an operation panel P1 equipped with four function keys for “Function A”, “Function B”, “Function C” and “Function D” whether or not any of the functions (A to D) of this image forming apparatus 1 are used. Here, for example, function A can correspond to the copy function, function B can correspond to the facsimile function, and the like.

Here, it is presumed that the function A is selected. The selected operation key is indicated with half-tone dot meshing. The same also applies hereafter. As a result, the control unit 10 deletes the operation panel P1 and displays a new operation panel P 2 as illustrated in FIG. 2B. On the operation panel P2, six operation keys “setting a1” to “setting a6” are provided. Here, setting a1 can be, for example, magnification, setting a2 can be paper selection, and the like.

Here, after setting a2 is selected, the control unit 10 displays a new operation panel P3 as illustrated in FIG. 2C. Four operation keys “setting a2-1” to “setting a2-4” are provided on the operation panel P3. These operation keys can correspond to the size of the paper, for example, in accordance with the selection of the above-mentioned paper.

Here, after setting a2-3 is selected, the control unit 10 displays a new operation panel P4 as illustrated in FIG. 2D. Four operation keys “setting a2-3-1” to “setting a2-3-4” are provided on the operation panel P4. These operation keys can be made to correspond to, for example, the size of the margin or the like in correspondence with selection of the paper as described above. Here, it is presumed that setting a2-3-4 is selected. Incidentally, in the above example, it is presumed that setting is performed by operating a certain operation key on any of the operation panels P1 to P4. However, not only the presence or absence of operation of a simple operation key, but also the number of output sheets that can be inputted may be set by input using an operation key, for example by setting a numerical value using an up key and down key.

As a result, the setting related to the selected function A is ended, and the function A is operated, for example, by the user operating a start key or the like provided separately from the above-described touch-panel display 11. Function A is, for example, a copy function. In other words, it is possible to perform an operation of copying and outputting a set original document to another sheet.

During the above-described operation, the control unit 10 can recognize that this user has performed “function A”, “setting a2”, “setting a2-3”, and “setting a2-3-4” in a stepwise manner. As a stepwise operation procedure for specifying such a procedure, it is possible to recognize a combination of “function A”, “setting a2”, “setting a2-3”, and “setting a2-3-4” as one data. The control unit 10 causes the stepwise operation procedure to be stored in the storage unit 13 together with the date and time when the operation is performed. Incidentally, the “function A”, “setting a2”, and the like as described above are actually stored in the storage unit 13 as coded information in a form that can be recognized later. The coded information is, for example, an ID number corresponding to an operation key, or a numerical value in the case of a numerical value setting such as described above or an ID number corresponding to this. This operation is performed each time this image forming apparatus 1 is used. In addition, the information of this kind of stepwise operation procedure is identified for each user and stored in the storage unit 13.

Therefore, for example, a case where the control unit 10 recognizes a user when this user uses this image forming apparatus 1 will be described. In this case, the most recent stepwise operation procedure by this user is read from the storage unit 13. Then, when newly displaying an operation panel on the touch-panel display 11, the touch-panel display 11 is made to perform a display based on the stored information as described above. This allows a setting to receive instructions from this user.

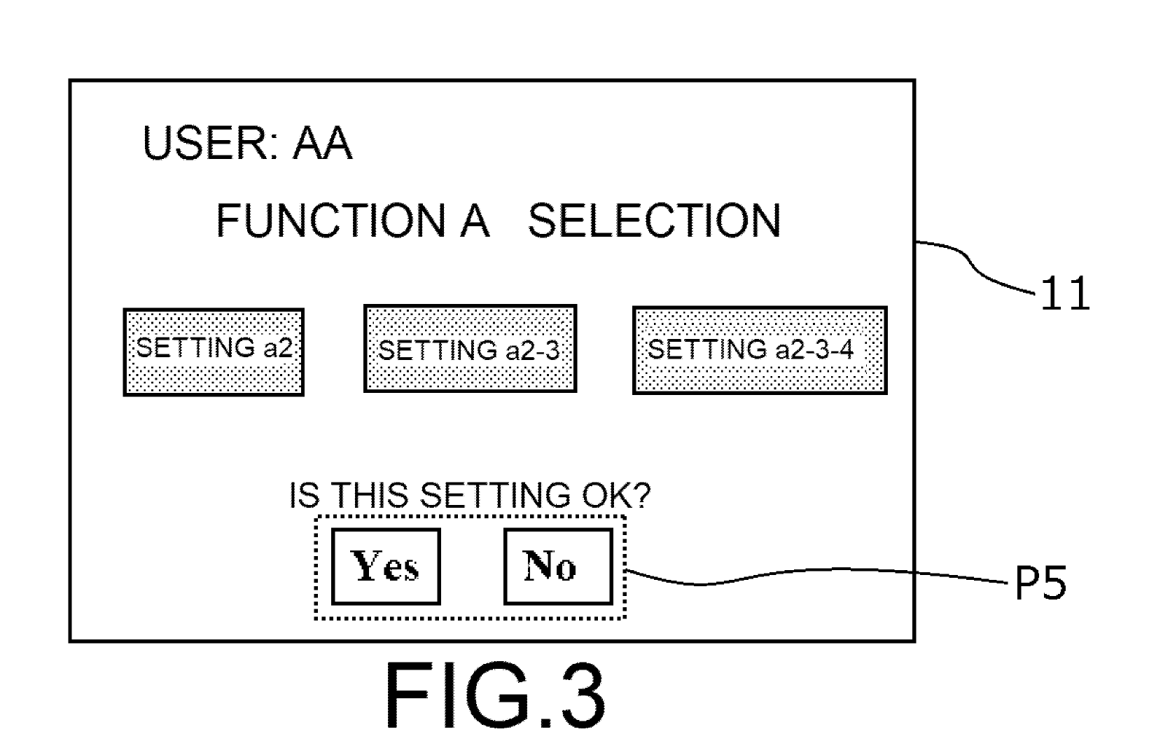

For example, in the case where this user uses this image forming apparatus 1 as the function A, the display in FIG. 2A is first performed. At this time, when the function A is selected, the control unit 10 reads the most recent stepwise operation procedure for function A from the storage unit 13. Here, in the case where the above-described combination “function A”, “setting a2”, “setting a2-3”, and “setting a2-3-4” is recognized as this stepwise operation procedure, the control unit 10, after that, can cause the display in FIG. 3 to be performed instead of the display in FIG. 2B. Here, “setting a2”, “setting a2-3”, and “setting a2-3-4”, which are the portion of the levels under the function A selected in the recognized stepwise operation procedure, are displayed simultaneously in one row in the horizontal direction. Here, in the case where the user wants this setting, the user operates the “Yes” key on the operation panel P5 to perform the setting according to this stepwise operation procedure, and it is possible to perform the same operation as that after the operation is performed on the screen in FIG. 2D. On the other hand, in the case where the user operates the “No” key on the operation panel P5, the display in FIG. 2 B is performed, and the subsequent operations can be performed in the same manner as described above.

In this case, when the user desires to perform the setting according to this stepwise operation procedure, this image forming apparatus 1 can be operated by a single operation of the “Yes” key. Therefore, by storing the stepwise operation procedure in the storage unit 13, the operation of this image forming apparatus 1 can be simplified.

However, in the case where the number of users and operation keys is large and the period of usage from the start of use of the image forming apparatus 1 becomes long, the number of stepwise operation procedures stored in the storage unit 13 as described above increases, so the amount of information to be stored increases. In order to suppress this, in this image forming apparatus 1, the control unit 10 reduces the amount of information stored by deleting a part of the information stored as a stepwise operation procedure after a certain amount of time elapses. This certain amount of time is a first holding time. Here, the items to be deleted and the first holding time can be determined by the control unit 10 according to, for example, the operation history of the operation key operated in the stepwise operation procedure, or an attribute of the operation key. This kind of data editing operation by the control unit 10 can be performed periodically, for example.

The contents of this editing operation will be described below. For example, the control unit 10 can read all of the past stepwise operation procedures when “function A” is selected from the storage unit 13. At this time, for example, among the operation keys for “setting a2-3-1” to “setting a2-3-4” in FIG. 2D, it is possible to recognize the cumulative number of times of operation that each operation key has been operated. The control unit 10 can set the above-described first holding time for each operation key according to this cumulative number of times of operation. For example, in FIG. 2B, it is presumed that the cumulative number of times of operation of “setting a2-3-1” to “setting a2-3-4” are Nₐ₂₃₁ to Nₐ₂₃₄, respectively. Then, the first holding time T₁₂₃ₖ (k=1 to 4) for each operation key is determined according to the value of Nₐ₂₃ₖ (k=1 to 4). Here, T₁₂₃ₖ can be set so as to increase as Nₐ₂₃ₖ becomes larger, for example, can be set so as to be proportional to N₂₃ₐₖ. As a result, the usage history for an operation key with low use frequency is deleted earlier, and the time until the usage history for an operation key with high usage frequency is deleted becomes longer.

For example, a combination of “function A”, “setting a2”, “setting a2-3”, and “setting a2-3-4” as described above exists as a stepwise operation procedure. However, the case will be explained in which, at the time when this determination is performed, the elapsed time from the time when this stepwise operation procedure is stored exceeds the first holding time T₁₂₃₄ that is set for “setting a2-3-4” as described above. In this case, the control unit 10 deletes the portion related to “setting a2-3-4” of the data of the stepwise operation procedure stored in the storage unit 13, or in other words, sets the data of this portion to Null.

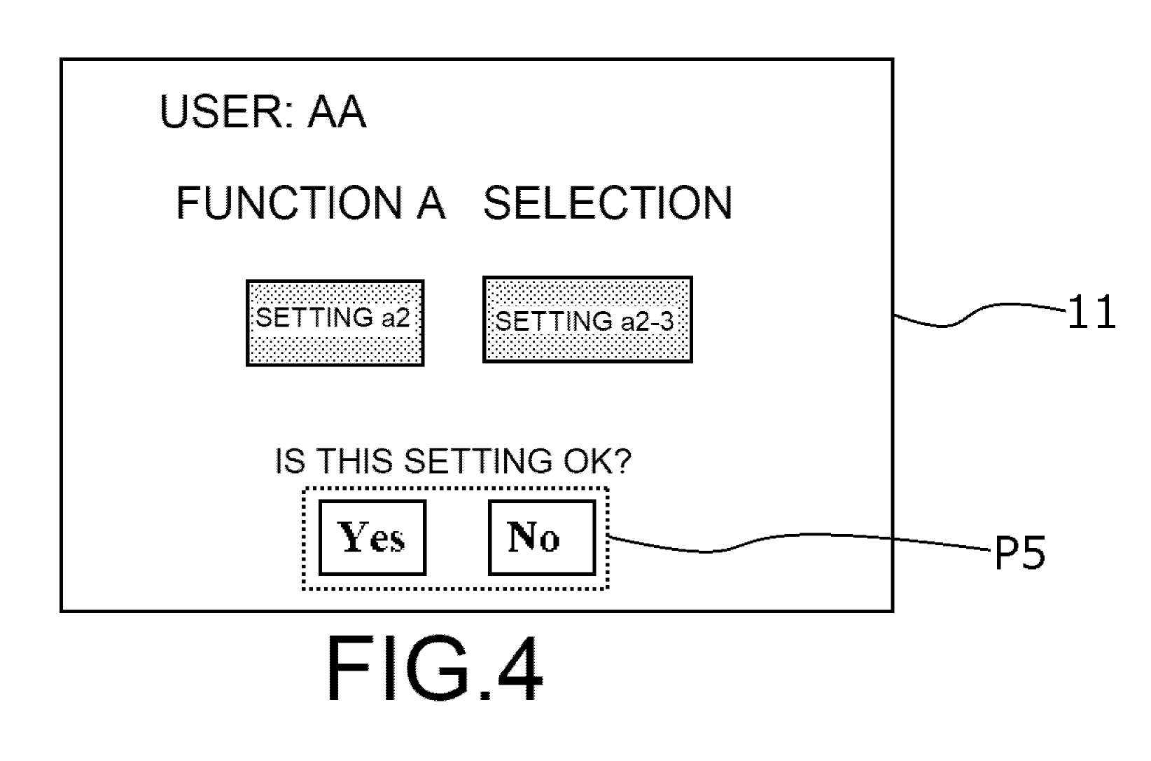

In the case where the control unit 10 receives “function A” from the screen in FIG. 2A after such editing is performed, instead of performing the display in FIG. 3, the control unit 10 performs the display in FIG. 4 in which the display of “setting a2-3-4” in FIG. 3 is deleted. After that, in the case where “Yes” is operated in FIG. 3, the operation is started, however, the operation when “Yes” in FIG. 4 is operated will be described. In this case, the display is moved to the display in FIG. 2D and the operation panel P4 is displayed for selecting “setting a2-3-1” to “setting a2-3-4”, and after this setting is performed, the operation is started. When this operation is performed, a stepwise operation procedure corresponding to this operation is newly stored in the storage unit 13.

Here, when the operation frequency of “setting a2-3-4” is high, even though the time elapsed since this stepwise operation procedure was stored is long, it becomes difficult to delete the operation of “setting a2-3-4” in this stepwise operation procedure, and the display in FIG. 3 is performed. In the above-described example, the first holding time T₁₂₃ₖ (k=1 to 4) for each operation key of “setting a2-3-1” to “setting a2-3-4” is used. However, similarly, a first holding time can also set for “setting a1” to “setting a6” in FIG. 2B, and “setting a2-1” to “setting a2-4” in FIG. 2 C, respectively, and in accordance with this, the usage history of each operation key can be deleted. For the setting of the level corresponding to the operation keys of which the use history is deleted, it is possible to display the corresponding operation panels (P2: FIG. 2B, P3: FIG. 2C) and make the setting.

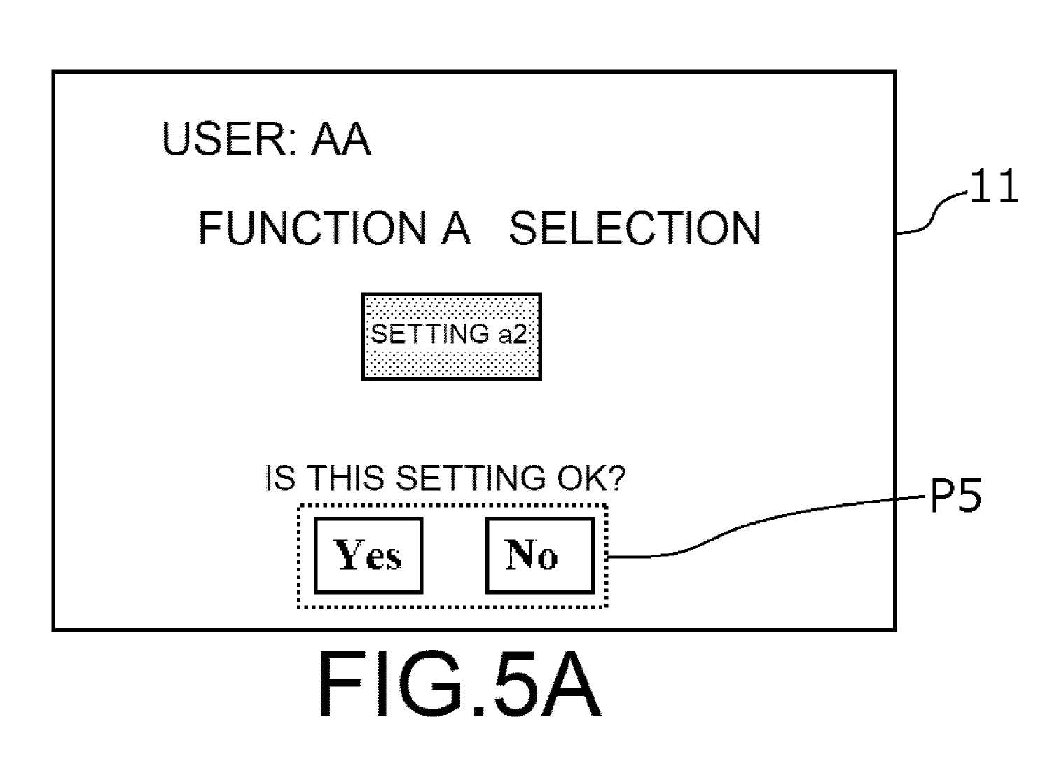

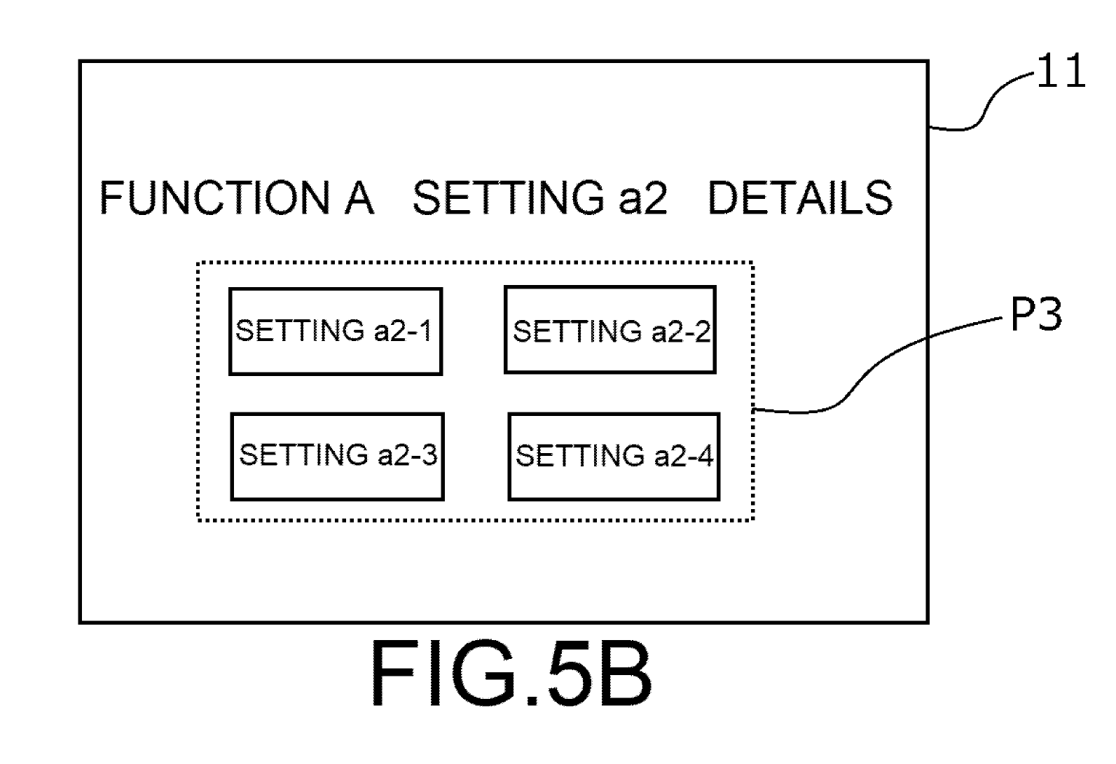

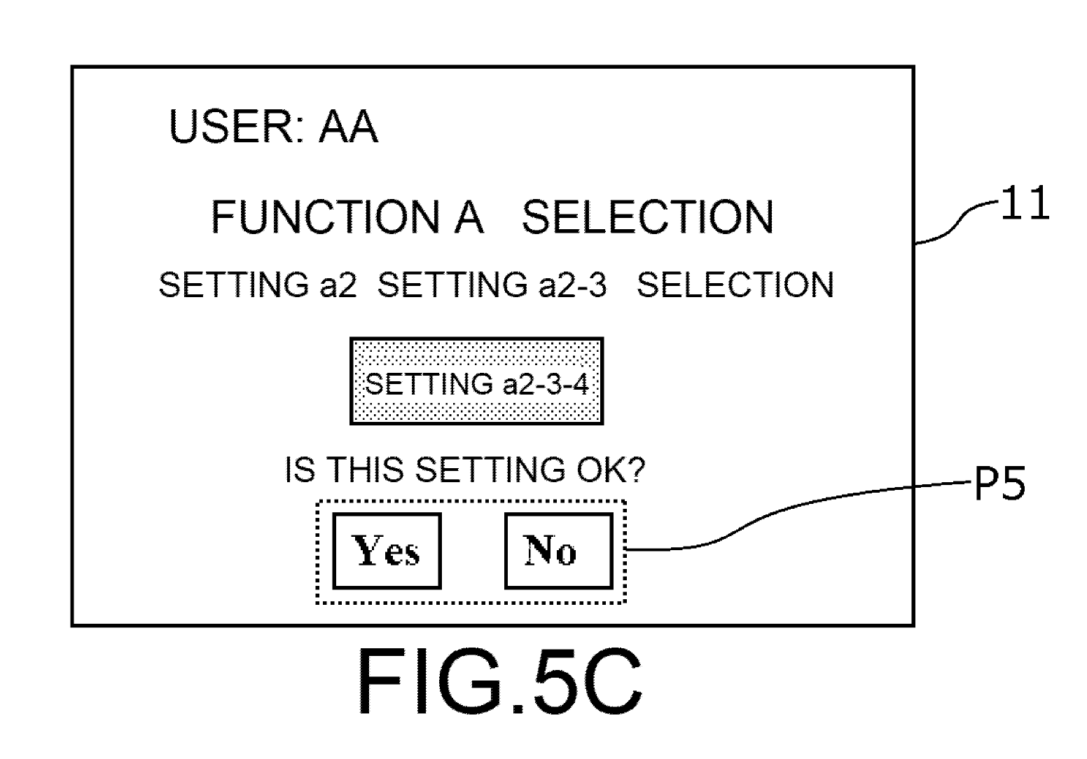

Here, for example, in the case where “setting a2-3” is deleted in the above-described stepwise operation procedure and “function A” is set (FIG. 2A), the control unit 10 causes the display in FIG. 5A to be performed instead of the display in FIG. 3 described above. Here, in the case where “No” is operated, the image in FIG. 2B is displayed. After that, according to the operated operation key, a stepwise display is performed according to the operation corresponding to FIG. 2C and FIG. 2D. When “Yes” on the operation panel P5 in FIG. 5A is operated, the screen in FIG. 5B in which the operation panel P3 for setting the level corresponding to “setting a 2-3” is used is displayed. Here, when “setting a2-3” is operated, the image in FIG. 5C corresponding to the lower level data in the above-described stepwise operation procedure is displayed. When an operation key other than “setting a2-3” is operated on the screen in FIG. 5B, a display corresponding to FIG. 2D is performed according to the operated operation key.

In this way, by the above-described operation, it is possible to realize an operation that can simplify the operation by reflecting the past operation history without inviting an increase in storage capacity. In the above example, it is presumed that the setting items that are performed when using this image forming apparatus 1 are as illustrated in FIGS. 2A to 2D. However, in reality, a large number of operation keys are set on the lower side corresponding to each operation key on the upper side in FIGS. 2A to 2D. Therefore, in actual practice, an extremely large total number of operation keys are used in this image forming apparatus, and there are a large number of stepwise operations corresponding to those operation keys. Therefore, the above-described control is particularly effective for simplifying the operation.

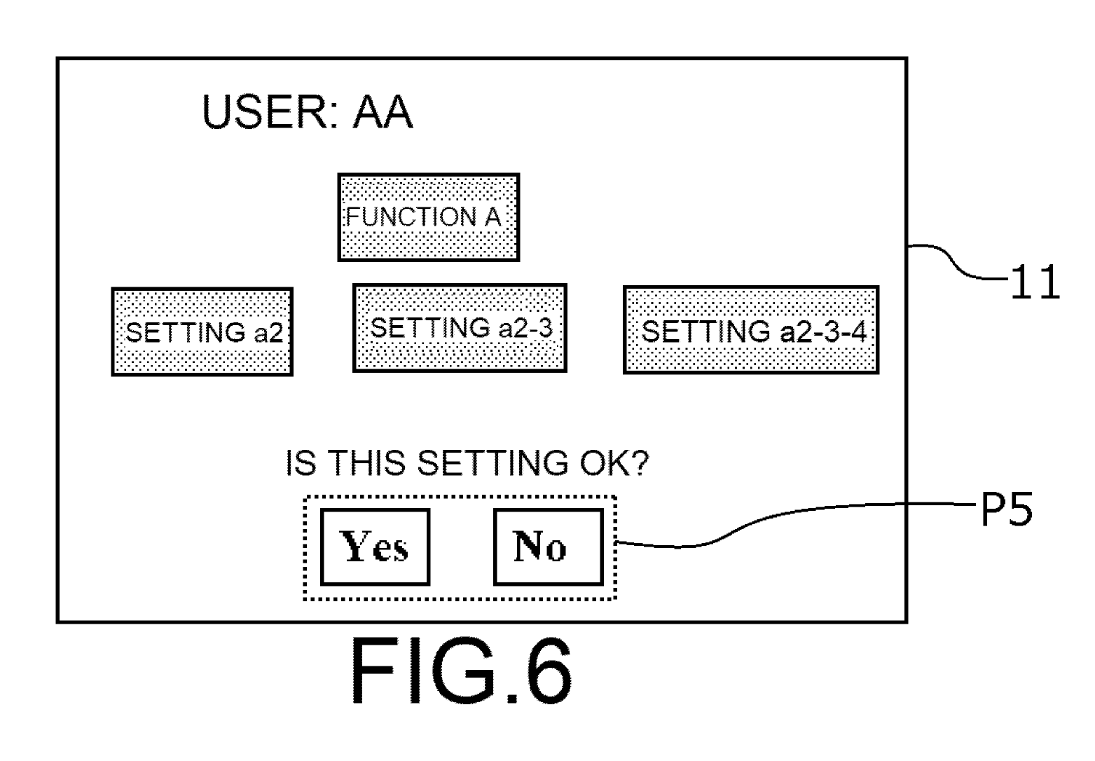

In the example described above, it is presumed that the operation using the stepwise operation procedure as described above is performed after the uppermost operation (function selection (FIG. 2A)) in this image forming apparatus 1, but a stepwise operation procedure that includes function selection can also be used. In this case, for example, after recognizing the user, the control unit 10 can cause a display as illustrated in FIG. 6 in which function A is set as the default to be performed, and similarly cause subsequent control to be performed in the same way. Conversely, the above-described control may also be applied to lower order operations. In that case, the stepwise operation procedure to be used is provided for each operation key that has been operated immediately before, and in the example in FIG. 3, the operation keys in the hierarchy of FIG. 2B and later corresponding to “function A” in FIG. 2A are used.

In the above example, the first holding time is set in accordance with the cumulative number of times of operation of the operation key, however instead of the cumulative number of times of operation, the first holding time may be set according to the operation frequency, or in other words, the number of operations within a certain period.

Moreover, instead of determining the first holding time based on the operation history of the operation keys such as the cumulative number of times of operation of the operation keys, the operation frequency, or the like, it is also possible to determine the first holding time based on the type (attribute) of the operation key. For example, in a stepwise operation as illustrated in FIGS. 2A to 2D, in general, the number of times operation is performed increases the higher the upper level of the operation key is. From a viewpoint such as this, lengthening the first holding time for the operation key of the upper level is effective for simplifying the operation.

On the other hand, the operation frequency in the upper level is not necessarily high, however when the operation of the higher level is performed, there are also operation keys having a high probability of being operated after that. For example, a case will be described in which paper generally used for documents in an office where the image forming apparatus 1 is installed is size A4. In this case, when “setting a2” on the operation panel P2 in FIG. 2B described above corresponds to the setting of paper, the probability that the operation key for specifying size A4 will be operated next on the operation panel P3 in FIG. 2C is high. In this case, it is preferable that the first holding time for the operation key for specifying size A4 be lengthened. On the other hand, the first holding time for the operation key for “setting a2” can be set independently of this. For example, the first holding time for the operation key for “setting a2” may be shorter than the first holding time for the operation key for specifying size A4. In this case, the first holding time is longer for the operation key of the lower level than for the operation key of the upper level. In this way, the first holding time can also be set according to the function and attribute of each operation key in each level. In the case where the first holding time is determined according to the cumulative number of times of operation as described above, the control unit 10 must periodically calculate the first holding time, for example. However, in the case where the first holding time is determined according to the attribute of the operation key in this manner, the first holding time corresponding to each operation key may be stored in advance in the storage unit 13.

In the above-described example, when a part of the data of the stepwise operation procedure stored in the storage unit 13 is deleted (assumed to be Null), settings made in the same way as in the case of FIG. 2, which does not use a stored stepwise operation procedure, may be performed for this item. However, in a case such as this, the control unit 10 can cause recommended contents to be displayed as the deleted items. As the recommended contents in this case, it is possible to store contents that are set in advance as initial conditions in the storage unit 13, and use those contents. For example, as described above, when the probability that size A4 will be specified as the paper size is high, it is possible to set size A4 to be recommended in the level for setting the paper size.

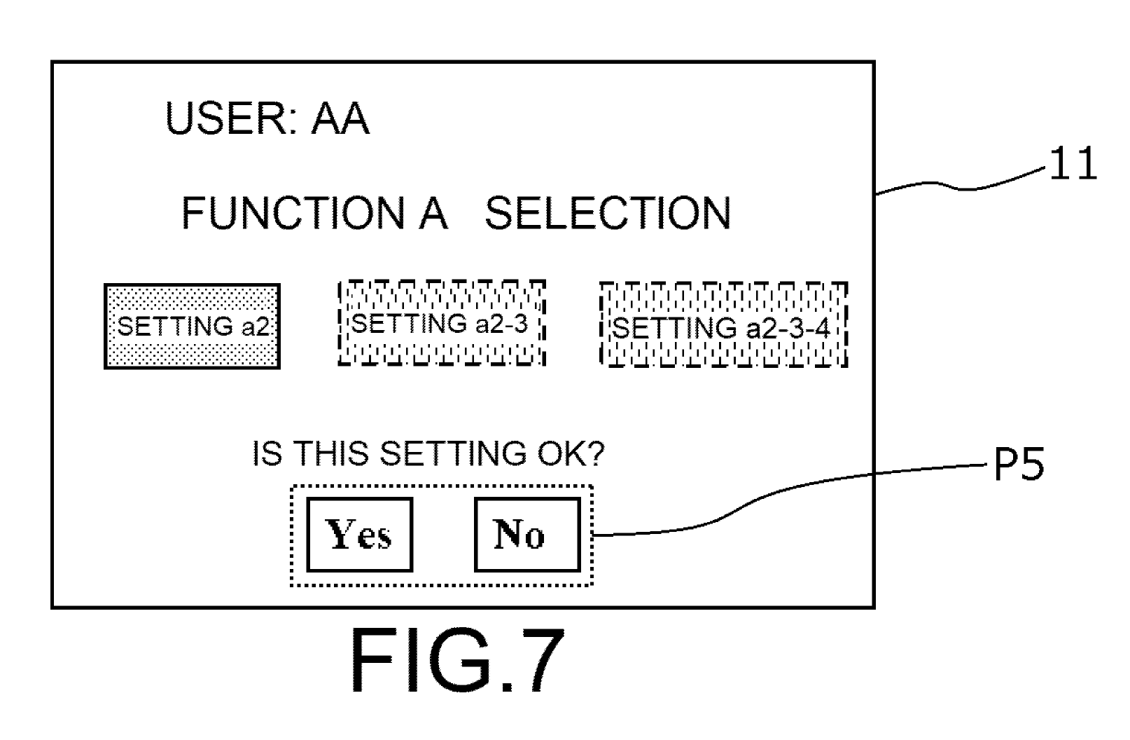

For example, “setting a2-3” in FIG. 2C corresponds to a setting for setting the paper size to A4. However, FIG. 7 is an example of a display performed instead of the display in FIG. 3, and illustrates a case when this item in the stepwise operation procedure is deleted because this operation key has not been operated for a long time. Also in this case, “setting a2-3” and “setting a2-3-4” are similarly illustrated, however these are displayed in a manner different from “setting a2” that remains as data in the stepwise operation procedure. More specifically, “setting a2” that remains as data in the stepwise operation procedure is indicated by a solid line. On the other hand, “setting a2-3” and “setting a2-3-4” that are left as recommended conditions because they were deleted are displayed using dashed lines and dotted lines. As a result, the user can recognize that the situations of “setting a2”, “setting a2-3”, and “setting a2-3-4” are different.

In this case, in each stored stepwise operation procedure, since a part of the data is deleted, the required storage capacity is reduced. On the other hand, since only one set of information set as the above-described recommended conditions is stored in the storage unit 13, the storage capacity required for this is also small. Therefore, even when the above-described operation is performed, the storage capacity used for the data of the stepwise operation procedure in the storage unit 13 can be reduced and the operation by the user can be simplified. Incidentally, in some cases, items deleted in the stepwise operation procedure may be numerical settings. In a case such as this, the above-described the recommendation condition is a recommended numerical value.

In the case of displaying the setting item corresponding to this data instead of the data deleted in the stepwise operation procedure as the recommended condition as described above, it is also possible to perform a setting so as not to display the recommended condition after the elapse of a second holding time that is longer than the above-described first holding time. In other words, when the corresponding operation key is not operated for a particularly long time in this way, the setting illustrated in FIG. 2 may be performed again. Like the above-described first holding time, this second holding time can be set according to the attribute of the operation key, the cumulative number of times of operation, and the like.

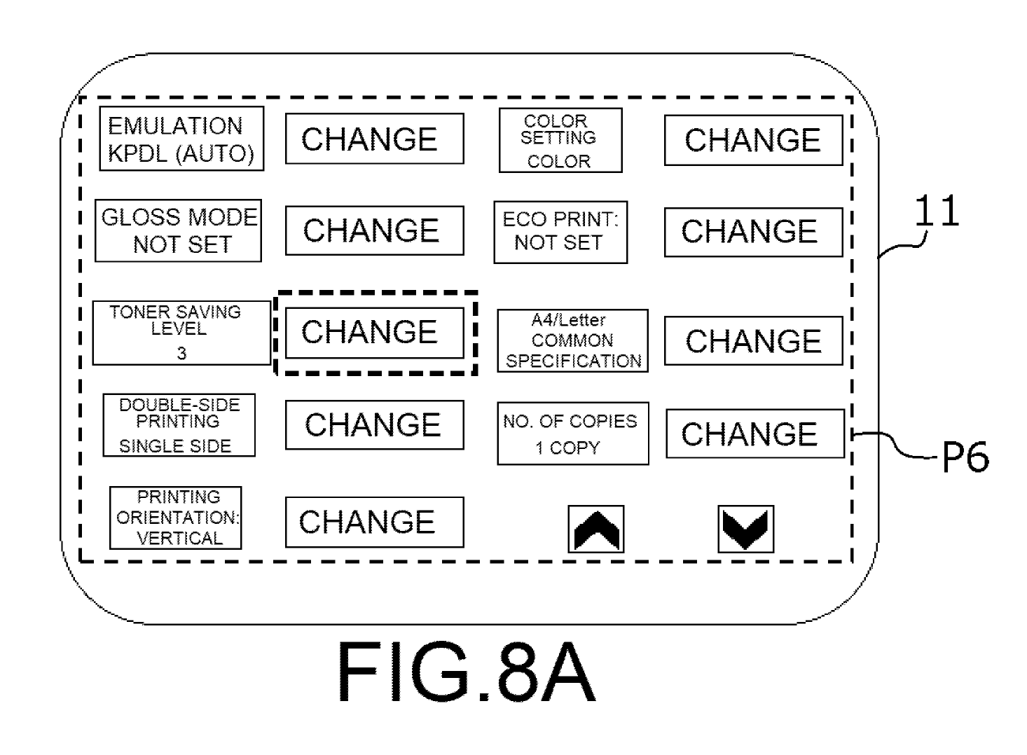

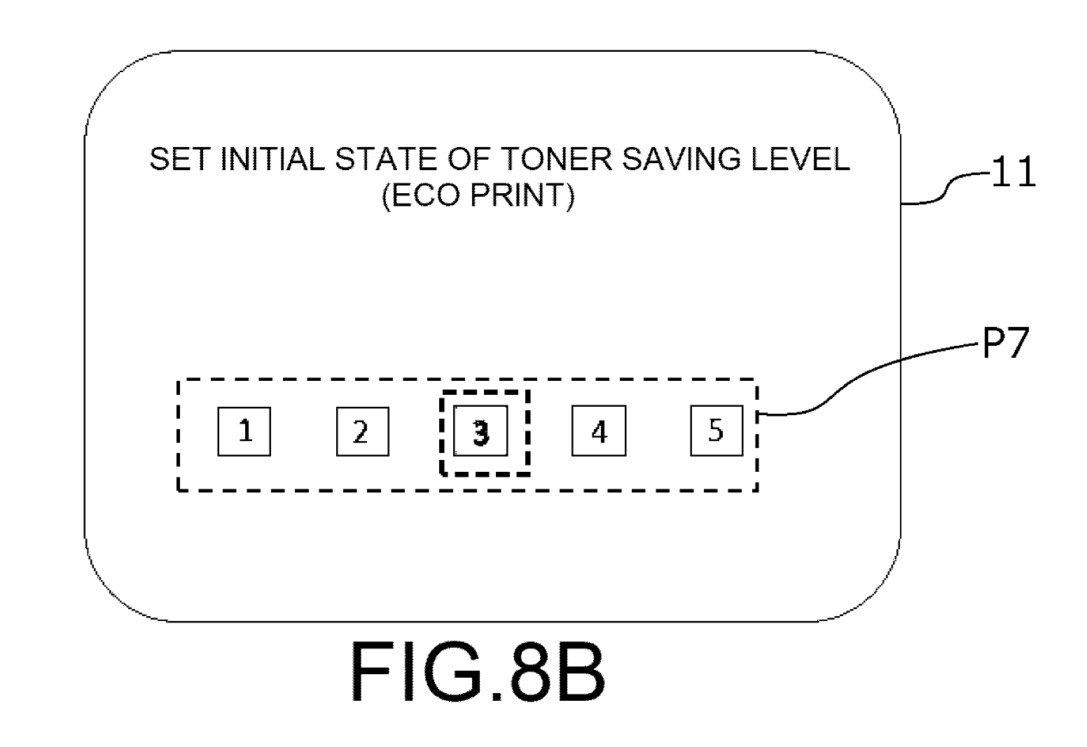

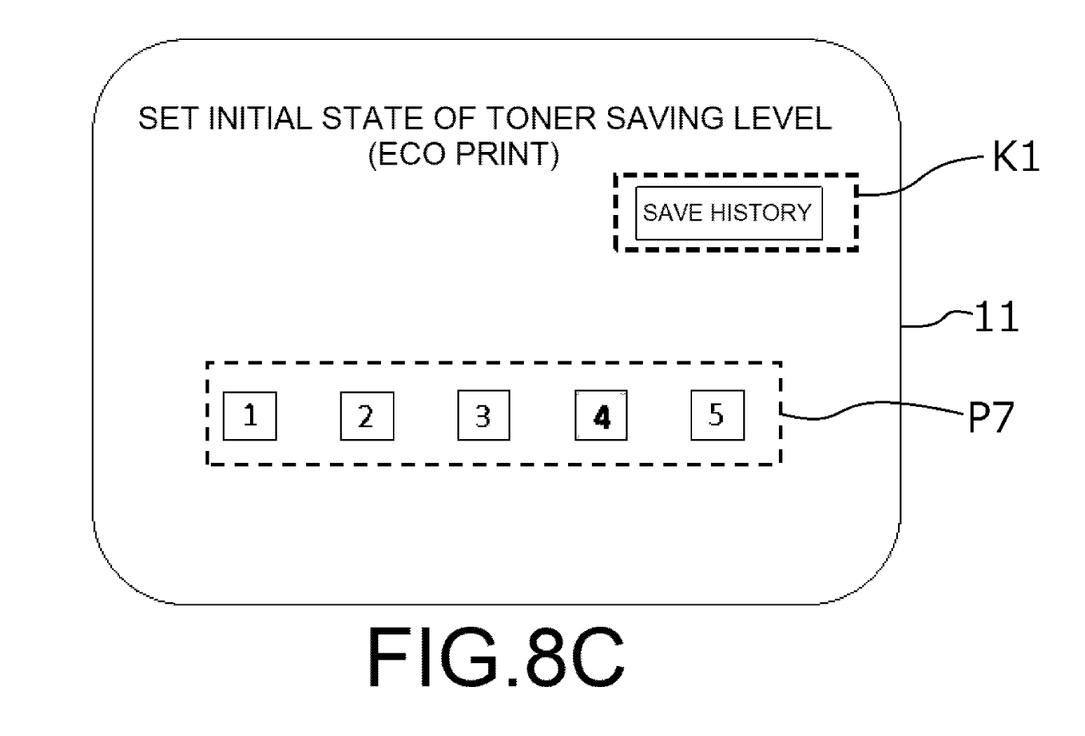

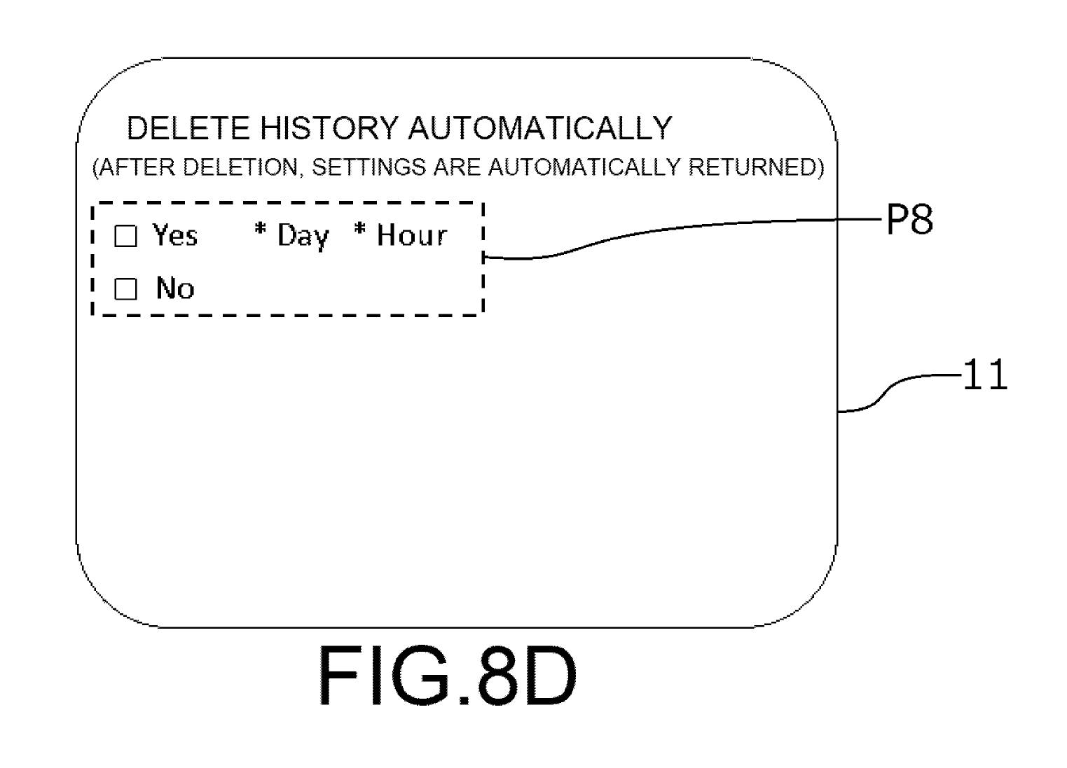

Moreover, in the stepwise operation procedure as described above it is not necessary to store all operations each time operations are performed. Alternatively, even in the case of storing operations, it is possible to allow the user to set a first holding time as described above. FIGS. 8A to 8D are examples of specific displays in such a case.

In FIG. 8A, an inquiry as to whether or not various settings in the printing function are to be changed is performed on the operation panel P6, and here, input such as changing the item of “toner saving level” is performed. FIG. 8B is a screen that is displayed thereafter on which the operation panel P7 for setting the toner saving level in five stages is displayed. Here, corresponding to FIG. 3 and the like, level “3” is set as the default. A case will be described in which the user after that performs a change to level “4” as illustrated in FIG. 8C. In this case, an inquiry is made as to whether or not to save this history, and in the case where “Save History” (save operation key K1) is not operated, the operation changing to this level “4” is not saved. Therefore, “3” is also displayed as the default as illustrated in FIG. 8B the next time a similar operation is performed.

In the case where “Save History” is operated in FIG. 8C, an operation panel P8 is displayed as illustrated in FIG. 8D making an inquiry as to whether or not to delete this history after the first holding time as described above, or in the case of deleting the history, inquiring as to which time scale to perform the deletion. Here, two types of time scales, “Day” and “Hour”, are set; where in the former case, the first holding time is set to be long (for example 1 day), and in the latter case the first holding time is set to be short (for example 1 hour).

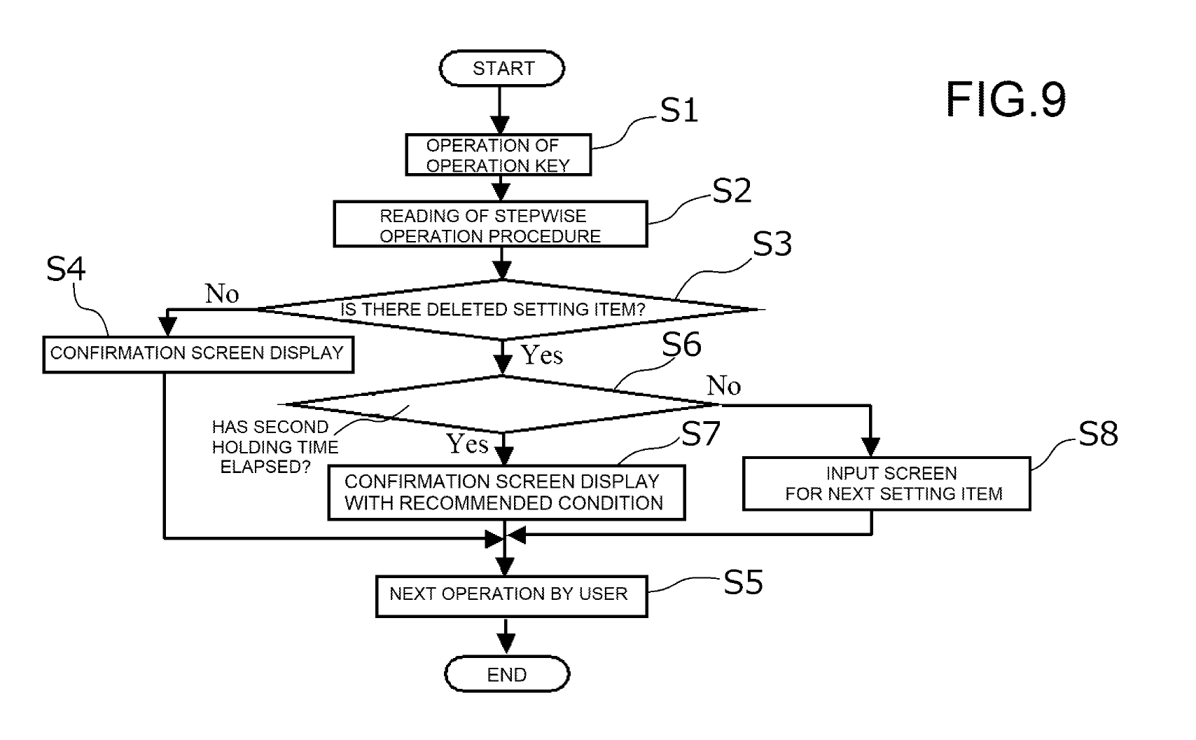

FIG. 9 is an example of a flowchart illustrating the operation of the control unit 10 in the case where a first holding time and a second holding period are set as described above, and an operation is performed by the user, or in other words, an operation key is operated. Here, when the operation is performed (S1), the control unit 10 reads the stepwise operation procedure corresponding to this operation from the storage unit 13 (S2). In the case where there is no Null item in the data of the read stepwise operation procedure (S3: NO), the control unit 10 causes the display corresponding to the above described FIG. 3 to be performed (S4), and waits for the operation for this (S5).

A case where there is a Null item in the data of the read stepwise operation procedure (S3: YES) will be described. In this case, the control unit 10, by the time recognition unit 14, recognizes the elapsed time from the moment the stepwise operation procedure is stored up to the present time. Then, in the case where this elapsed time is shorter than the second holding time (S6: YES), the control unit 10 causes the Null item to be displayed as the recommended condition stored in the storage unit 13 as illustrated in FIG. 7 (S7), and waits for the operation for this (S5).

A case in which this elapsed time exceeds the second holding time (S6: NO) will be described. In this case, as illustrated in FIGS. 5A to 5C, when the next setting item is not Null, the control unit 10 makes an inquiry such as illustrated in FIG. 5A and FIG. 5C. Then, in the case where the next setting item is Null, the control unit 10 performs an inquiry as illustrated in FIG. 5B and waits for the operation for this (S8). However, even when there is a Null item, the control unit 10 may perform an inquiry (S4) according to the read stepwise operation procedure for the level higher than the Null item, and may perform an inquiry such as illustrated in FIG. 5B for only the Null item. The correspondence in the case where there is a Null item may be set according to the contents of the item.

In the above-described example, a touch-panel display is used as the display unit, and the operation panel is displayed thereon, however, even in the case where the display unit and the operation panel are separate, the above configuration is effective. The above configuration is particularly effective in a multifunction peripheral having many setting items and having a large number of users because of its multifunctionality. However, since an image forming apparatus generally has many setting items, the above-described configuration is effective in all image forming apparatuses. Moreover, the above-described configuration is similarly effective for general electrical apparatuses having many setting items.

In the typical technique described above, when a user has performed many kinds of different operations in the past, determining which operation to newly select after recognizing which purpose each operation performed in the past is for is not easy for the user.

In addition, past operation history storage is recognized for each user and stored. For this reason, in the case where there is a large number of users, a large storage capacity is required. Alternatively, in the case where a storage unit that stores various data used in the operation of a multifunction peripheral is used for this purpose, depending on the history data, reading and writing data used in the operation takes time, and may adversely affect the operation speed in some cases.

With the above-described configuration, it is possible to realize an operation that can simplify the operation by reflecting the past operation history by the user without inviting an increase in storage capacity.

What is claimed is:

1. An electrical apparatus that uses an operation panel equipped with a plurality of keys to be operated by a user, and during use, by using the operation panel operated by the user in a stepwise manner according to the operation of the user, the electrical apparatus operates after various settings are performed; the electrical apparatus comprising:
a storage unit that stores a stepwise operation procedure that specifies operations performed by the user on the stepwise operation panel in the past; and
a control unit that causes the stepwise operation procedure stored in the storage unit to be displayed, and prompts the user to operate the operation panel; wherein
the control unit deletes a part of information of the stepwise operation procedure stored in the storage unit after a first holding time that is set according to an attribute or operation history of the operation key related to the part of the information on the operation panel has elapsed.

2. The electrical apparatus according to claim 1, wherein the control unit, in a case where the stepwise operation procedure that includes a operation performed on the operation panel is stored in the storage unit, causes a portion corresponding to a level lower than that operation in the stepwise operation procedure to be simultaneously displayed.

3. The electrical apparatus according to claim 2, wherein
the control unit
after the first holding time elapses and before a second holding time that is longer than the first holding time elapses
causes at least the part of the information in the stepwise operation procedure stored in the storage unit to be modified and displayed as a recommended condition that is set according to the attribute or the operation history of the operation key.

4. The electrical apparatus according to claim 3, wherein the control unit causes the portion in the stepwise operation procedure to be displayed in a row arrangement, and causes information other than the part in the stepwise operation procedure to be displayed using solid lines, and causes the part of the information designated to be the recommended condition to be displayed using dashed lines or dotted lines.

5. The electrical apparatus according to claim 3 wherein the second holding time is set according to an attribute or operation history of the operation key related to the part of the information.

6. The electrical apparatus according to claim 1 wherein
the control unit
during usage by the user, causes an inquiry to be made as to whether or not the stepwise operation procedure during that usage is stored in the storage unit, and according to the response, causes the stepwise operation procedure to be stored in the storage unit.

7. The electrical apparatus according to claim 1 wherein a touch-panel display that displays the operation panel in a stepwise manner is equipped.

8. The electrical apparatus according to claim 1 is an image forming apparatus that causes an image to be formed on a medium and outputted.
